(19) United States
(12) Patent Application Publication
(10) Pub. No.: US 2007/0157190 A1
(43) Pub. Date: Jul. 5, 2007

(54) System and Method for Online Application Development and Operation

(76) Inventor: Martin Shiu, Newton, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/618,231

(22) Filed: Dec. 29, 2006

Related U.S. Application Data
(60) Provisional application No. 60/755,038, filed on Dec. 30, 2005.

(51) Int. Cl. G06F 9/44

(52) U.S. Cl. 717/162

(57) ABSTRACT

The present invention is a system for application creation and use. It includes an application development engine and a plurality of interfaces. The interfaces allow access to the application development engine from a network, such as the internet. The application development engine allows modular creation of software and execution of the software. The interfaces provide security for the system and add functionality for different types of access to the application development engine. Through the use of the interfaces, users can create or modify programs individually or through collaborations, operate existing programs, and obtain copies of all or parts of programs.

### CROSS REFERENCES TO RELATED APPLICATIONS

Priority is claimed to U.S. Provisional Patent Application No. 60/755,038, filed Dec. 30, 2005.

### BACKGROUND OF THE INVENTION

1. Field of the Invention

The present invention relates to the creation and execution of software applications. More particularly, it relates to the creation and execution of software using a general purpose application development engine through a networked environment.

2. Discussion of Related Art

The processes for creating computer software have evolved over time. In part, these changes resulted from changes in computer hardware and programming languages. Computing hardware has undergone significant changes in the past several decades. Processing speeds have increased dramatically. The physical size of memory has shrunk while the capacity has expanded. Correspondingly, the size of computer programs have expanded. Only minimal limitations of size or speed are placed upon current programmers. The global networking phenomenon has also further altered programming. The computing environment is not limited to a single, independent machine which processes programs serially. Computers are formed into networks of independently operating machines which coordinate processing and program display or output. Such networks include local area, wide area, and global networks. These networks include various machines with different hardware, operating systems, and control processes.

Similarly, the programming process has undergone significant changes. Initially, computer programs were written in machine language which were sets of binary codes, generally represented as hexadecimal numbers. However, the codes were complex and required extensive knowledge and experience to create, read, review or modify. Furthermore, variations existed in the machine language between computers. Thus, programming languages developed. A programming language provides a syntax for writing programs in a form similar to ordinary language. A compiler, which is itself a computer program, can read the syntax and convert it to machine language. Of course, the compiler had to provide the correct language for the corresponding machine. A specific program was platform specific and could not be easily transferred between machines.

Additionally, with the advent of the compiler and programming languages, greater flexibility was created in the software creation process. The programming language syntax allowed functionality to be separated and reused as individual modules. Thus, processes could be repeated without recreating the same software code. Subsequent programming languages expanded upon the defined syntax to allow greater flexibility and enhanced operations.

Nevertheless, the process for creating a computer program remained complex and time consuming. Any change in the code required the entire program to be compiled again. For a large program, the compilation process could be extensive. Programs, both before and after compiling, remained platform specific. They could not be used on dissimilar machines.

With networking, the programming process changed again. Previously, programs were installed and executed on a single machine. With a network, programs could be located and executed anywhere in the network. The results of the program could also occur anywhere in the network. Thus, universality became important in program operation. Mechanism were developed to transfer data and programs throughout the network. Hypertext Markup Language (HTML) developed for controlling the display of data transferred to different machines throughout a network. Similarly, Extensible Markup Language (XML) developed for controlling the format of data transferred to different machines. Finally, Java programming developed for transfer of programs or applications throughout a network. Using these features, applications can communicate over a network to provide additional functionality, resources and information.

Most recently, outsourcing and collaboration have been major factors in the process of computer programming. With outsourcing, programmers in far off locations are tasked with creating parts of code for complex software. They often do so with explicit instructions on part of the code and with minimal understanding to the software as a whole. Similarly, collaborative efforts can combine many good ideas, but when operating separately, the collaborators lack an understanding of the entire software and their respective parts.

The problems with prior and existing software creation systems illustrate a need for a process which allows easy creation of and coherent operation of software parts. They illustrate a need for a system which can be utilized over a large scale and diverse network. They illustrate the need to reutilize code and prevent duplication of prior efforts.

### SUMMARY OF THE INVENTION

The present invention overcomes many of the deficiencies of existing software creation and execution systems through the use of an application development engine connected to a network. An application development engine, according to an aspect of the present invention, provides the simple creation and reuse of software code in multiple applications. With these aspects of creation and reuse, the application development engine simplifies collaboration and outsourcing of code development through the modular nature of the system. According to one aspect of the invention, a plurality of interfaces are used to access the application development engine from a network. The interfaces are designed to allow different types of operations in the development and use of software. Interfaces may include programming, execution, collaboration, web services, and web site operation. According to another aspect of the invention, the system allows creation of an online marketplace for computer code and/or services in creation and operation of new software.

### BRIEF DESCRIPTION OF THE DRAWINGS

FIG. 1 is a block diagram of a system according to an embodiment of the present invention.

### DETAILED DESCRIPTION

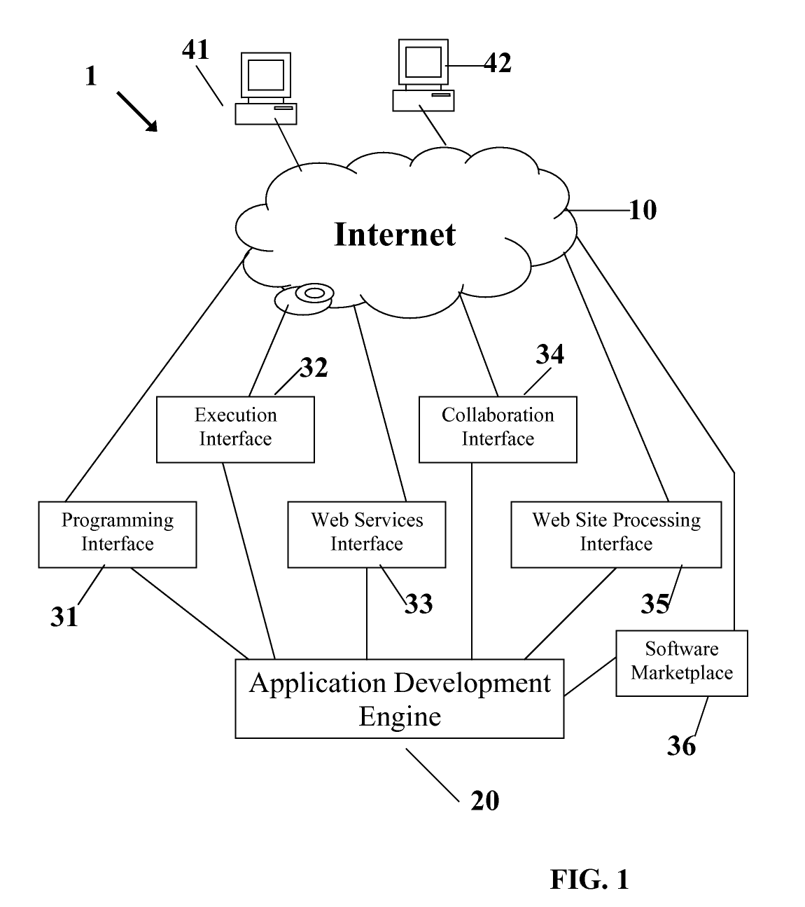

The present invention is a system for creating and executing software in a networked environment. An embodiment of the invention is illustrated in FIG. 1. The system 1 includes an application development engine 20. According to the present invention, an application development engine 20 is a computer system which allows programming and execution of software on a modular basis. U.S. Pat. No. 6,925,632 illustrates an embodiment of an application development engine 20 within the present invention. The application development engine 20 is connected to the Internet 10 or other network through a plurality of interfaces 31-36. The interfaces 31-36 allow different types of interactions with the application development engine 20. Client computers 41, 42 connect to the interfaces 31-36 through the network 10 to allow remote operation of the application development engine.

The interfaces 31-36 control access to the application development engine 20 and provide functionality for certain types of operations. The interfaces 31-36 are illustrative of the types of control and functionality which can be part of the system 1. The present invention is not limited to the specifics of these interfaces.

A programming interface 31 allows access to the application development engine 20 for purposes of creating code. According to an embodiment of the invention, the programming interface 31 operates as a gatekeeper to permit access only to authorized persons, such as subscribers to customers of the system. Such access may be controlled through the use of IDs and passwords, as is commonly known. Furthermore, access through the Internet 10 may be controlled through SSL sessions, encrypted communications or other security measures to prevent unauthorized access. Security will also limit the portions of the application development engine which may be accessed by the user. Thus, a user will be granted access only to the programs created by that user. The application development engine 20 may be accessed by many disparate users. Each user will be able to create his or her own programs without interference from other users. The programs remain within the application development engine 20.

An execution interface 32 allows operation of programs in the application development engine. As with the programming interface 31, the execution interface 32 may control access to authorized users. Once the user gains access to the system, a list of available programs for execution is provided. The list may be limited to those programs created by the user. Alternatively, a program owner/creator may allow access by others, such as licensees, to the program. Additionally, program execution may be performed by the public, if authorized by the owner/creator. The execution interface may also function as a marketplace for programs. A user may be presented with a list of programs available, but may be allowed to access certain programs through the interface only after paying a licensing fee and obtaining authorization.

The web services interface 33 allows programs or portions thereof to be accessed as web services. Web services are known as a way for users to have access to certain functionality either directly or through another application. The web services may be created through the web services interface 33 or through the programming interface 31. Access to the web services, as with other access, may be controlled to authorized users. Such access control will be based upon individual services.

A collaboration interface 34 allows multiple parties to access all or portions of programs within the application development engine 20. The collaboration interface 34 also allows communication between the various users of specified programs. Thus, it can be used for multiple parties, such as individual users or organizations, to work together on a program development project. It can also be used for outsourcing of program development. The communication capability will allow proposals for work to be shared. The program, or part thereof, can be created, for the owner within the collaborative environment of the collaboration interface 34.

The web site processing interface 35 is a specialized execution interface 32 used for operation of a website. Many websites include functionality from programming, such as ASP or back-end sales processing. Programs created with and stored on the application development engine 20 can be used to provide this functionality. The website may be stored at another location and may simply access the system through the web site processing interface 35 as necessary to perform the desires functionality.

The software marketplace 36 is an interface for transfers of software. As discussed above, the application development engine 20 allows the easy creation of software applications or portions thereof. Furthermore, portions of software applications can be easily utilized to complete diverse applications. The web services interface 33 and collaboration interface 34 allow portions of applications to be utilized by different parties. The software marketplace 36 provides a framework for the purchase and sale of portions of software for use in creating applications. The software marketplace 36 can be created as a online store or an auction site, as is known in the art. The software marketplace 36 provides a list of available application portions for sale, license or lease. A user may access the application portions upon payment of the proper fees. The user may then utilize that portion of an application in creating a complete application. The software marketplace 36 controls the payment process and maintenance of license rights to application portions within the application development engine.

The system of the present invention does not require a single application development engine 20. Multiple organizations may have an application development engine 20 with appropriate interfaces to carry out all of the desire operations of such organizations. Furthermore, programs created through the system of the present invention may be downloaded by the user for operation without the network. In such a case, the user would also download at least a portion of the application development engine necessary for operation of the program.

Having disclosed at least one embodiment of the present invention, various adaptations, modifications, additions, and improvements will be readily apparent to those of ordinary skill in the art. Such adaptations, modifications, additions and improvements are considered part of the invention.

1. A computer programming and execution system comprising:
an application development engine including:
a library storing a plurality of computer software modules;
at least one program having a combination of one or more computer software modules stored in the library; and
an execution engine for executing the at least one program; and
a plurality of interfaces for accessing the library of computer software modules and the at least one program.

2. The computer programming and execution system according to claim 1, wherein the plurality of interfaces includes an authentication system for authenticating a user before allowing access to the library of computer software modules and the at least one program.

3. The computer programming and execution system according to claim 1, wherein the plurality of interfaces includes at least one interface having:
means for selecting at least one computer software module from the library; and
means for creating a combination of the selected at least one computer software module to create a program.

4. The computer programming and execution system according to claim 1, wherein the plurality of interfaces includes an interface for selecting the at least one program to be executed on the execution engine.

5. The computer programming and execution system according to claim 1, further comprising a financial transaction interface for receiving payment prior to allowing access to the library and the at least one program.
